(19) United States
(12) Patent Application Publication
(10) Pub. No.: US 2018/0217373 A1
(43) Pub. Date: Aug. 2, 2018

(54) ROTARY DRIVE APPARATUS

(71) Applicant: Nidec Corporation, Kyoto (JP)

(72) Inventor: Yoichi SEKII, Kyoto (JP)

(21) Appl. No.: 15/663,883

(22) Filed: Jul. 31, 2017

(30) Foreign Application Priority Data
Jan. 27, 2017 (JP) 2017-012935

(51) Int. Cl. G02B 26/10; H02K 7/02

(52) U.S. Cl. CPC G02B 26/105; H02K 7/02

(57) ABSTRACT

This rotary drive apparatus is arranged to rotate a flywheel arranged to support an optical component arranged to reflect incoming light coming from a light source or allow the incoming light to pass therethrough, and includes a motor including a rotating portion; the flywheel, the flywheel being supported by the motor and arranged to rotate about a central axis extending in a vertical direction; and an elastic member. The flywheel includes an accommodating portion in which the optical component is arranged. In the accommodating portion, at least a portion of the optical component is arranged opposite to at least a portion of the flywheel with the elastic member intervening therebetween. Examples of the optical component include a mirror arranged to reflect the incoming light, and a lens arranged to allow reflected light obtained by a mirror reflecting the incoming light to pass therethrough.

### CROSS REFERENCE TO RELATED APPLICATIONS

This application claims the benefit of priority to Japanese Patent Application No. 2017-012935 filed on Jan. 27, 2017. The entire contents of this application are hereby incorporated herein by reference.

### BACKGROUND OF THE INVENTION

### 1. Field of the Invention

The present invention relates to a rotary drive apparatus.

### 2. Description of the Related Art

A known scanner apparatus used for position recognition in combination with a head-mounted display (HMD) or the like typically has installed therein a mirror arranged to reflect incoming light coming from a light source, and a light guide member arranged to guide the incoming light and reflected light. Such a known optical apparatus including a mirror and a light guide member is described in, for example, JP-A 2010-021105.

In the optical apparatus described in JP-A 2010-021105, a reflecting surface arranged to reflect illuminating light coming from a light source, and the light guide member, which is arranged to guide the illuminating light, are defined by a single monolithic member. In addition, the light guide member is fixed to a base. Therefore, depending on precision of the light guide member, the position and angle of the reflecting surface may be changed, which may affect emission of reflected light from the reflecting surface.

### SUMMARY OF THE INVENTION

A rotary drive apparatus according to a preferred embodiment of the present invention is arranged to rotate a flywheel arranged to support an optical component arranged to reflect incoming light coming from a light source or allow the incoming light to pass therethrough, and includes a motor including a rotating portion; the flywheel, the flywheel being supported by the motor and arranged to rotate about a central axis extending in a vertical direction; and an elastic member. The flywheel includes an accommodating portion in which the optical component is arranged. In the accommodating portion, at least a portion of the optical component is arranged opposite to at least a portion of the flywheel with the elastic member intervening therebetween.

According to the above preferred embodiment of the present invention, the optical component is fixed in the accommodating portion, which is defined in the flywheel, through the elastic member. This contributes to preventing a displacement of the optical component, and to securely fixing the optical component.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view of a rotary drive apparatus, a light source, and a frame according to a first preferred embodiment of the present invention.

FIG. 2 is a vertical sectional view of the rotary drive apparatus according to the first preferred embodiment.

FIG. 3 is a perspective view of a flywheel according to the first preferred embodiment.

FIG. 4 is a perspective view of the flywheel according to the first preferred embodiment.

FIG. 5 is a perspective view of a mirror according to the first preferred embodiment.

FIG. 6 is a partial vertical sectional view of the flywheel according to the first preferred embodiment.

FIG. 7 is a perspective view of an elastic member according to the first preferred embodiment.

FIG. 8 is a perspective view of an optical component, the elastic member, and an accommodating portion according to the first preferred embodiment.

FIG. 9 is a perspective view of an optical component and an elastic member according to a modification of the first preferred embodiment.

FIG. 10 is a partial vertical sectional view of a flywheel according to a modification of the first preferred embodiment.

### DETAILED DESCRIPTION OF THE PREFERRED EMBODIMENTS

Hereinafter, preferred embodiments of the present invention will be described with reference to the accompanying drawings. It is assumed herein that a direction parallel to a central axis of a motor, which will be described below, is referred to by the term “axial direction”, “axial”, or “axially”, that directions perpendicular to the central axis of the motor are each referred to by the term “radial direction”, “radial”, or “radially”, and that a direction along a circular arc centered on the central axis of the motor is referred to by the term “circumferential direction”, “circumferential”, or “circumferentially”. It is also assumed herein that an axial direction is a vertical direction, and that a side on which a light source is arranged with respect to the motor is defined as an upper side. The shape of each member or portion and relative positions of different members or portions will be described based on the above assumptions. It should be noted, however, that the above definitions of the vertical direction and the upper side are not meant to restrict in any way the orientation of a rotary drive apparatus according to any preferred embodiment of the present invention when in use. Also note that the term “parallel” as used herein includes both “parallel” and “substantially parallel”. Also note that the term “perpendicular” as used herein includes both “perpendicular” and “substantially perpendicular”.

### 1. First Preferred Embodiment

### 1-1. Structure of Rotary Drive Apparatus

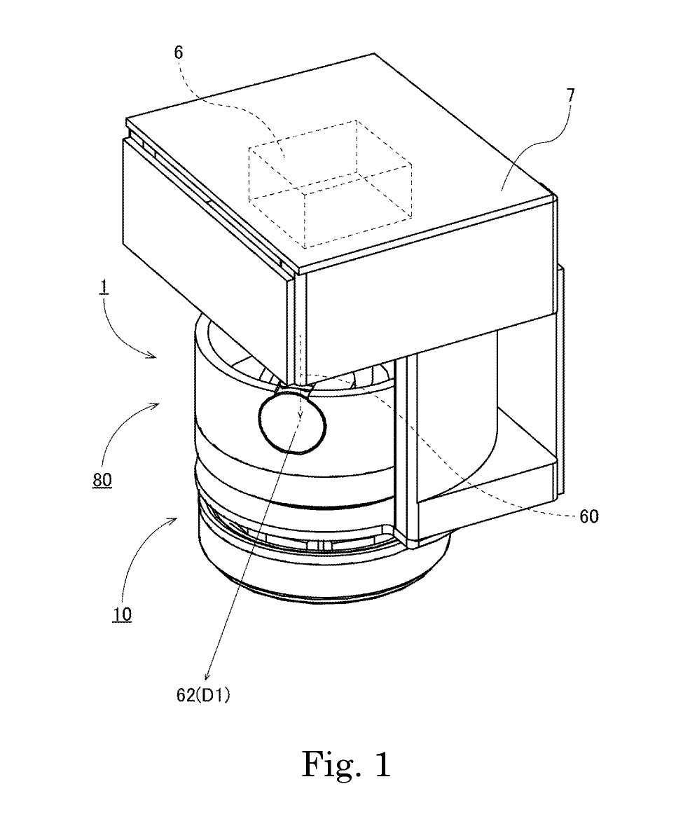

FIG. 1 is a perspective view of a rotary drive apparatus 1, a light source 6, and a frame 7 according to a first preferred embodiment of the present invention. The rotary drive apparatus 1 is an apparatus arranged to support and rotate a mirror 61, which is arranged to reflect incoming light 60 coming from the light source 6 in a radial direction (i.e., a first radial direction D1), and a lens 63, and emit reflected light 62 obtained by the mirror 61 reflecting the incoming light 60 to an outside of the rotary drive apparatus 1 through the lens 63, which will be described below, while rotating the mirror 61, which will be described below. The frame 7, in which the light source 6 is installed, is arranged above the rotary drive apparatus 1. The frame 7 is fixed to a case or the like in which the rotary drive apparatus 1 is arranged. The incoming light 60, which travels downward along a central axis 9 of a motor 10, is emitted from the light source 6. In the present preferred embodiment, the light source 6 and the frame 7 are arranged outside of the rotary drive apparatus 1. Note, however, that each of the light source 6 and the frame 7 may alternatively be included in the rotary drive apparatus 1.

Referring to FIG. 1, the rotary drive apparatus 1 includes the motor 10, a flywheel 80, and elastic members 5, which will be described below.

### 1-2. Structure of Motor

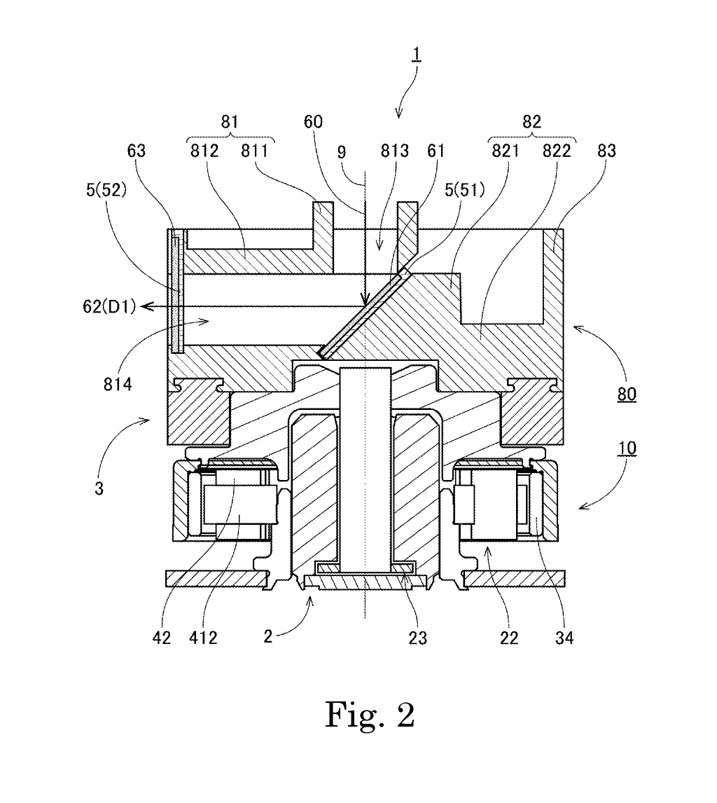

Next, the structure of the motor 10 will now be described below. FIG. 2 is a vertical sectional view of the rotary drive apparatus 1 according to the first preferred embodiment.

Referring to FIG. 2, the motor 10 includes a stationary portion 2 including a stator 22, and a rotating portion 3 including a magnet 34. The stationary portion 2 is arranged to be stationary relative to the case or the like in which the rotary drive apparatus 1 is arranged. The rotating portion 3 is supported through a bearing portion 23 to be rotatable about the central axis 9, which extends in the vertical direction, with respect to the stationary portion 2.

Once electric drive currents are supplied to coils 42 included in the stationary portion 2, magnetic flux is generated around each of a plurality of teeth 412, which are magnetic cores for the coils 42. Then, interaction between the magnetic flux of the teeth 412 and magnetic flux of the magnet 34 included in the rotating portion 3 produces a circumferential torque between the stationary portion 2 and the rotating portion 3, so that the rotating portion 3 is caused to rotate about the central axis 9 with respect to the stationary portion 2. Thus, the flywheel 80, which is rotatably held by the rotating portion 3, is caused to rotate about the central axis 9 together with the rotating portion 3.

As the bearing portion 23, a fluid dynamic bearing, in which a portion of the stationary portion 2 and a portion of the rotating portion 3 are arranged opposite to each other with a gap in which a lubricating oil exists therebetween and which is arranged to induce a fluid dynamic pressure in the lubricating oil, is used, for example. Note that a bearing of another type, such as, for example, a rolling-element bearing, may alternatively be used as the bearing portion 23.

### 1-3. Structure of Flywheel

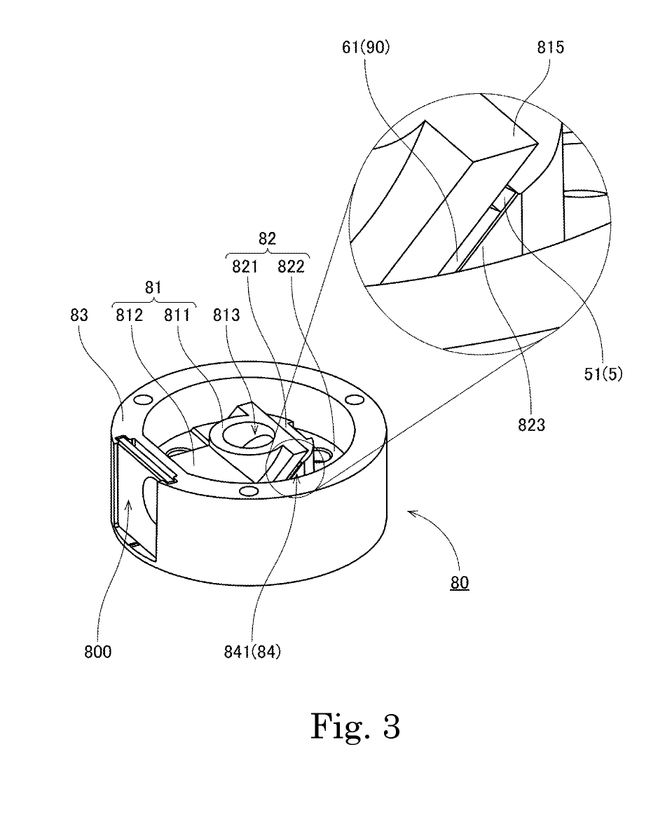

Next, the structure of the flywheel 80 will now be described below. Hereinafter, reference will be made to FIGS. 1 and 2 appropriately as well as FIGS. 3, 4, and 5.

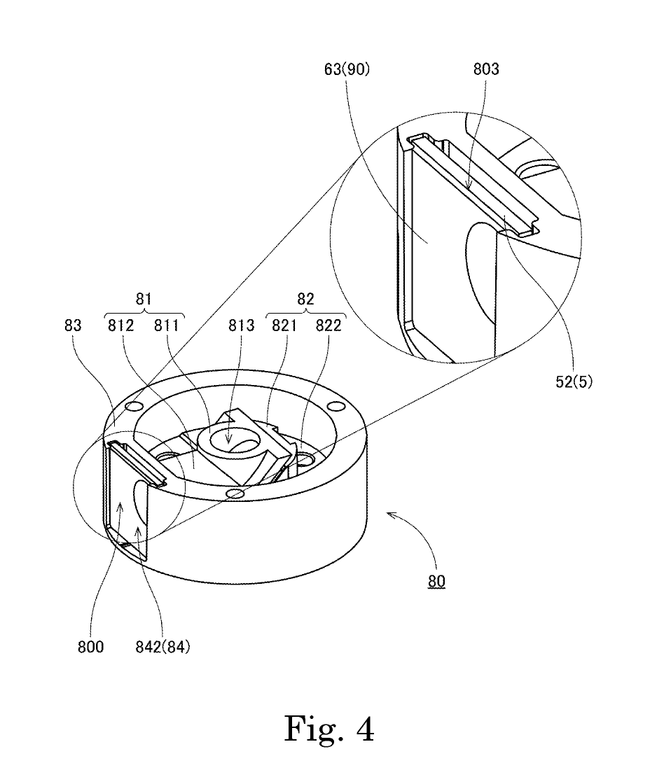

Each of FIGS. 3 and 4 is a perspective view of the flywheel 80 according to the first preferred embodiment. The flywheel 80 is supported by an upper end portion of the rotating portion 3 of the motor 10, and is arranged to rotate about the central axis 9 together with the rotating portion 3. The flywheel 80 is fixed to an upper surface of the rotating portion 3 through, for example, engagement, an adhesive, or the like. Referring to FIGS. 3 and 4, the flywheel 80 includes optical components 90, an upper support member 81, a lower support member 82, an outer cylindrical portion 83, and accommodating portions 84, which will be described below. The optical components 90 include the mirror 61, which is arranged to reflect the incoming light 60, and the lens 63, which is arranged to allow the reflected light 62 obtained by the mirror 61 reflecting the incoming light 60 to pass therethrough. A resin, for example, is used as a material of the flywheel 80.

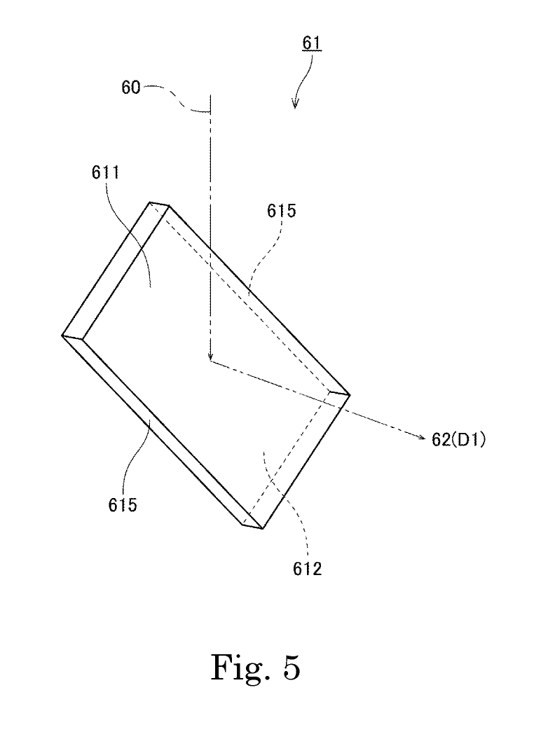

FIG. 5 is a perspective view of the mirror 61 according to the first preferred embodiment. Referring to FIG. 5, the mirror 61 is in the shape of a flat rectangular parallelepiped. In other words, the mirror 61 is in the shape of a rectangular plate. In a situation in which the mirror 61 is fixed to the flywheel 80, the mirror 61 has at least a portion thereof arranged on the central axis 9, and is inclined at an angle of 45° with respect to the axial direction and the first radial direction D1. In addition, the mirror 61 is arranged to extend in the shape of a plate, and is fitted and fixed in an accommodating portion 841, which will be described below, through an elastic member 51, which will be described below. This contributes to preventing a displacement of the mirror 61, and to securely fixing the mirror 61. The incoming light 60 impinges on a central portion of an upper surface 611, which is a reflecting surface, of the mirror 61. The central portion of the upper surface 611 refers to the entire upper surface 611, excluding a peripheral portion of the upper surface 611. A fully reflective mirror, for example, is used as the mirror 61.

The upper support member 81 is a tubular member including an upper vertical cylindrical portion 811 and an upper horizontal cylindrical portion 812. In the present preferred embodiment, the upper vertical cylindrical portion 811, the upper horizontal cylindrical portion 812, the lower support member 82, and the outer cylindrical portion 83 are defined as a single monolithic member by a resin injection molding process. Note, however, that the upper vertical cylindrical portion 811, the upper horizontal cylindrical portion 812, the lower support member 82, and the outer cylindrical portion 83 may alternatively be defined by separate members.

The upper vertical cylindrical portion 811 is a cylindrical portion arranged to extend in the axial direction from a radially inner end portion of the upper horizontal cylindrical portion 812. An inner circumferential surface of the upper vertical cylindrical portion 811 is arranged to extend in parallel with the central axis 9 of the motor 10. A cavity 813 radially inside of the upper vertical cylindrical portion 811 is arranged to define a light path.

The upper horizontal cylindrical portion 812 is a cylindrical portion arranged to extend outward in a radial direction (i.e., in the first radial direction D1) from an outer circumferential portion of the upper vertical cylindrical portion 811. A cavity 814 inside of the upper horizontal cylindrical portion 812 is joined to the cavity 813 radially inside of the upper vertical cylindrical portion 811 at right angles. In addition, the cavity 814 inside of the upper horizontal cylindrical portion 812, the mirror 61, and the lens 63 are arranged to overlap with one another when viewed in the first radial direction D1.

Further, the upper support member 81 includes an upper periphery support portion 815 arranged to extend outward from a lower end portion of the upper vertical cylindrical portion 811 and a radially inner end portion of the upper horizontal cylindrical portion 812. The upper periphery support portion 815 is arranged to be in contact with the peripheral portion of the upper surface 611 of the mirror 61 in the situation in which the mirror 61 is fixed to the flywheel 80. This contributes to more securely fixing the mirror 61.

The outer cylindrical portion 83 is a cylindrical member arranged to extend along the central axis 9 radially outside of the upper support member 81. An outer circumferential surface of the outer cylindrical portion 83 defines a portion of an outer circumferential surface of the flywheel 80. In addition, a through hole 800, which is arranged to pass through the outer cylindrical portion 83 in the first radial direction D1, is defined in the outer cylindrical portion 83 at a circumferential position radially outside of the upper horizontal cylindrical portion 812. In addition, a radially outer end portion of the upper horizontal cylindrical portion 812 is joined to an inner circumferential surface of a portion of the outer cylindrical portion 83 which surrounds the through hole 800. The outer cylindrical portion 83 and the upper support member 81 are thus joined to each other.

The lower support member 82 includes a lower vertical cylindrical portion 821 and a joining portion 822. The lower vertical cylindrical portion 821 is a columnar member arranged to extend in the axial direction, and having at least a portion thereof arranged below the upper support member 81. Note that the lower vertical cylindrical portion 821 may alternatively be arranged to have a tubular structure and include a cavity (not shown) radially inside thereof. Also note that the cavity (not shown) radially inside thereof may be arranged to define a light path.

In addition, the lower support member 82 includes a lower periphery support portion 823 arranged to extend outward from an upper end portion of the lower vertical cylindrical portion 821. The lower periphery support portion 823 is arranged to be in contact with a peripheral portion of the elastic member 51, which is fixed to the mirror 61 and which will be described below, in the situation in which the mirror 61 is fixed to the flywheel 80. This contributes to more securely fixing the mirror 61 and the elastic member 51.

The joining portion 822 is arranged to extend radially inward from a portion of an inner circumferential surface of the outer cylindrical portion 83, and is joined to an outer circumferential surface of the lower vertical cylindrical portion 821. Thus, the outer cylindrical portion 83 and the lower support member 82 are joined to each other.

A portion of the outer cylindrical portion 83 and a portion of the joining portion 822 are recessed radially inward from outer circumferential surfaces thereof at one circumferential position. Each of these portions is arranged to axially and radially overlap with a radially outer portion of the upper horizontal cylindrical portion 812 of the upper support member 81 in the situation in which the mirror 61 is fixed to the flywheel 80. In the present preferred embodiment, the outer cylindrical portion 83 and the radially outer portion of the upper horizontal cylindrical portion 812 are joined to each other in the vicinity of these portions when the upper support member 81, the lower support member 82, and the outer cylindrical portion 83 are defined by the resin injection molding process.

Similarly to the mirror 61, the lens 63 is in the shape of a plate. The lens 63 is fitted and fixed in an accommodating portion 842, which will be described below, through an elastic member 52, which will be described below. This contributes to preventing a displacement of the lens 63, and to securely fixing the lens 63. The lens 63 is arranged to extend in the shape of a plate, and is arranged at right angles to the first radial direction D1, that is, in parallel with the central axis 9, in a situation in which the lens 63 is fixed in the flywheel 80. The reflected light 62, which is obtained by the mirror 61 reflecting the incoming light 60, passes through a central portion of the lens 63. The central portion of the lens 63 refers to the entire lens 63, excluding a peripheral portion of the lens 63.

The incoming light 60, which is emitted from the light source 6, enters the above-described flywheel 80 from above an upper surface of the flywheel 80, and travels downward along the central axis 9 in the cavity 813 radially inside of the upper vertical cylindrical portion 811. The incoming light 60 is then reflected by the mirror 61, and, further, travels outward in the first radial direction D1 in the cavity 814 inside of the upper horizontal cylindrical portion 812, and is emitted out of the rotary drive apparatus 1 through the lens 63.

The mirror 61 of the flywheel 80 is arranged to reflect the incoming light 60 from the light source 6 and emit the reflected light 62 to the outside while rotating about the central axis 9 together with the rotating portion 3 of the motor 10. Therefore, the first radial direction D1, which is a direction in which the reflected light 62 is emitted, also rotates together with the rotating portion 3. Thus, a wide range can be irradiated with light. Note that the outer circumferential surface of the flywheel 80 has a reflectivity lower than that of a surface of the mirror 61. This contributes to preventing diffuse reflection of the incoming light 60 from the light source 6.

Note that the rotary drive apparatus 1 may further include, in addition to the flywheel 80 arranged to emit the reflected light 62 to the outside in the first radial direction D1, another flywheel (not shown) which is arranged to emit reflected light to the outside in a second radial direction different from the first radial direction D1, and which is arranged, for example, below the motor 10. In this case, a half mirror the transmissivity and reflectivity of which are substantially equal is used as the mirror 61. Then, a half of the incoming light 60 which impinges on the mirror 61 in the flywheel 80 is reflected in the first radial direction D1 to be emitted to the outside. In addition, a remaining half of the incoming light 60 which impinges on the mirror 61 passes through the mirror 61, and travels downward in the cavity radially inside of the lower vertical cylindrical portion 821. Further, a through hole (not shown) passing through the motor 10 in the axial direction is defined around the central axis 9 in the motor 10. Thus, the portion of the incoming light which has passed through the mirror 61 passes through the through hole and reaches the other flywheel arranged below the motor 10. In this other flywheel, this portion of the incoming light 60 is reflected in the second radial direction to be emitted to the outside.

When light is emitted out in the two different directions, i.e., the first radial direction D1 and the second radial direction, as described above, light beams that are emitted out in the two different directions take different times to reach an object to be irradiated with light while the motor 10 is rotating, and this makes it possible to precisely recognize the three-dimensional position of the object in a space. Note that the other flywheel may alternatively be arranged in a rotary drive apparatus (not shown) other than the rotary drive apparatus 1 including the flywheel 80.

### 1-4. Structures of Accommodating Portions and Elastic Members

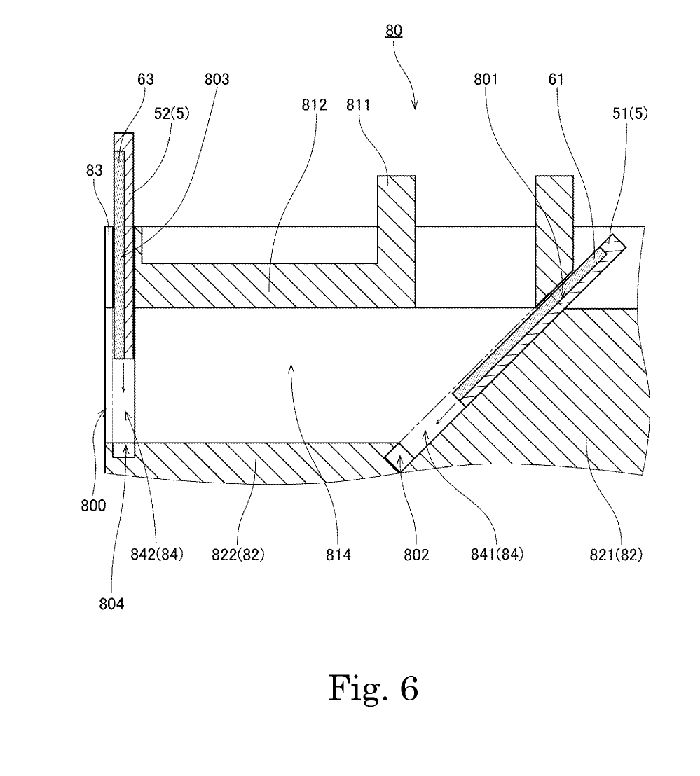

Next, the structures of the accommodating portions 84 and the elastic members 5 will now be described below. Hereinafter, reference will be made to FIGS. 1 to 5 appropriately as well as FIGS. 6, 7, and 8.

First, one of the elastic members 5 which is arranged to hold the mirror 61, which is one of the optical components 90, will now be described below. The one of the elastic members 5 which is arranged to hold the mirror 61 will be hereinafter referred to as the “elastic member 51”. FIG. 6 is a partial vertical sectional view of the flywheel 80 according to the first preferred embodiment, illustrating a portion of the flywheel 80 when the mirror 61 and the lens 63 are arranged therein. Referring to FIG. 6, at least a portion of a lower surface of the upper vertical cylindrical portion 811 and at least a portion of an upper surface of the lower vertical cylindrical portion 821 are arranged opposite to each other with a gap 801 therebetween. In addition, the accommodating portion 841, which is a space in the shape of a plate, is defined by the gap 801, a portion of the cavity 814, and an inner recessed portion 802 recessed inward from an upper surface of the lower support member 82. In FIG. 6, the accommodating portion 841 is represented by a chain double-dashed line. The accommodating portion 841 is arranged to be larger than the mirror 61.

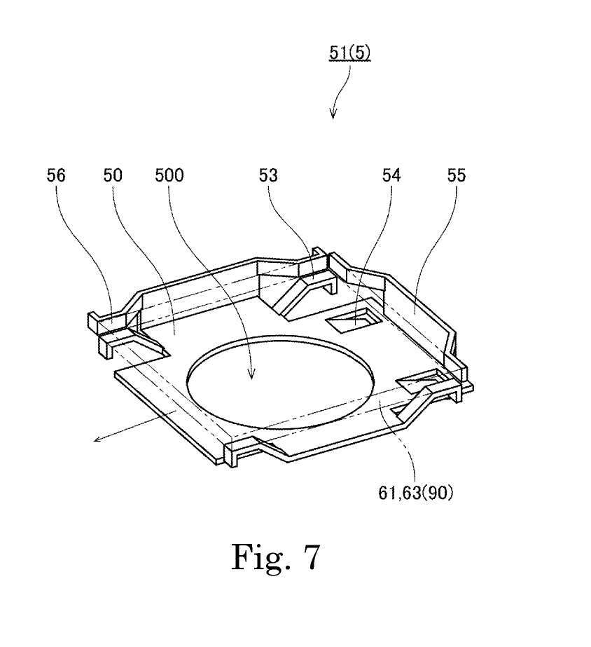

Next, the structure of the elastic member 51 will now be described below. FIG. 7 is a perspective view of the elastic member 51 (5) according to the first preferred embodiment. Referring to FIG. 7, the elastic member 51 includes a plate-shaped main body 50, spring portions 53, return portions 54, and a fixing portion 55. A metal or a resin harder than the flywheel, for example, is used as a material of the elastic member 51. In the present preferred embodiment, the main body 50, the spring portions 53, the return portions 54, and the fixing portion 55 are defined by a single monolithic member. Note, however, that the main body 50, the spring portions 53, the return portions 54, and the fixing portion 55 may alternatively be defined by separate members. The elastic member 51 includes a through hole 500 arranged to pass through the main body 50. In the case where a half of the incoming light 60 which impinges on the mirror 61 is allowed to pass through the mirror 61 and travel downward as described above, the through hole 500 defined in the elastic member 51 allows the portion of the incoming light 60 which has passed through the mirror 61 to pass through the through hole 500 and travel downward below the elastic member 51.

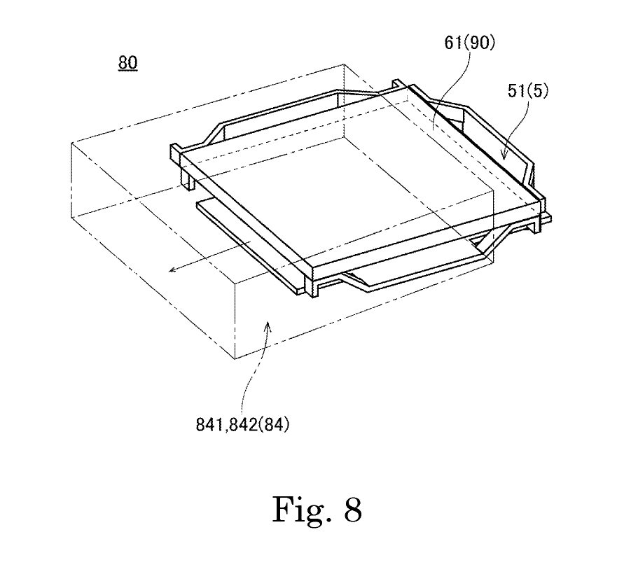

FIG. 8 is a perspective view of the mirror 61, the elastic member 51 (5), and the accommodating portion 841 (84) according to the first preferred embodiment. Referring to FIG. 8, at least a portion of the elastic member 51 is attached to a peripheral portion of a lower surface 612 of the mirror 61 or the lens 63 through, for example, adhesion, soldering, welding, screwing, or engagement before the mirror 61 or the lens 63 is inserted and fixed in the flywheel 80. The elastic member 51, and the mirror 61 or the lens 63 can thus be securely fixed to each other. In addition, a reduction in the likelihood that the mirror 61 or the lens 63 will be displaced with respect to the elastic member 51 is achieved. Further, fixing the elastic member 51 to a peripheral portion of the mirror 61 or the lens 63 contributes to preventing a light path of each of the incoming light 60 and the reflected light 62 from being blocked. Referring to FIGS. 6 to 8, the mirror 61 and the elastic member 51 are inserted into the accommodating portion 841, with the elastic member 51 being fixed to the peripheral portion of the mirror 61 or the lens 63.

Referring to FIG. 7, each spring portion 53 is arranged to be capable of expanding and contracting in a direction perpendicular to a direction (i.e., a direction in which the mirror 61 and the elastic member 51 are inserted into the accommodating portion 841, that is, a direction indicated by a straight-line arrow in FIG. 7) in which the mirror 61 extends. That is, the spring portion 53 is arranged to be capable of expanding and contracting in a thickness direction of the plate-shaped mirror 61. This allows the mirror 61 and the elastic member 51 to be easily inserted into the accommodating portion 841 even when the thickness of the plate-shaped accommodating portion 841, or a contact surface between a surface of the flywheel 80 which defines a portion of the accommodating portion 841 and the mirror 61 or the elastic member 51, has a low degree of precision. In addition, after the mirror 61 and the elastic member 51 are inserted into the accommodating portion 841, the mirror 61 is arranged in the accommodating portion 841 through the elastic member 51. Further, in the accommodating portion 841, at least a portion of the mirror 61 is arranged opposite to at least a portion of the flywheel 80 with the elastic member 51 intervening therebetween. At this time, each spring portion 53 of the elastic member 51 contracts in the thickness direction of the mirror 61, and accordingly, the mirror and the elastic member 51 are securely fixed in the accommodating portion 841 after being accommodated in the accommodating portion 841. This contributes to preventing a displacement of the mirror 61. In the present preferred embodiment, the number of spring portions 53 of the elastic member 51 is four. Note, however, that the number of spring portions 53 is not limited to four.

Referring to FIG. 7, the elastic member 51 may further include a side surface spring portion 56 arranged to be capable of expanding and contracting in a direction perpendicular to the direction in which the plate-shaped mirror 61 extends and perpendicular to the thickness direction of the plate-shaped mirror 61. This allows the mirror 61 and the elastic member 51 to be easily inserted into the accommodating portion 841 even when a surface of the flywheel 80 which defines a portion of the accommodating portion 841 and which is opposed to a lateral side surface 615 of the mirror 61 has a low degree of precision. In addition, the lateral side surface 615 of the mirror 61 is thus securely fixed after the mirror 61 and the elastic member 51 are accommodated in the accommodating portion 841. This contributes to more effectively preventing a displacement of the mirror 61.

Each return portion 54 is arranged to project from at least a portion of the elastic member 51 in a direction away from the mirror 61 with respect to a direction perpendicular to the direction in which the plate-shaped mirror 61 extends. In addition, the return portion 54 is angled in a direction opposite to the direction in which the mirror 61 is inserted into the accommodating portion 841 as the return portion 54 extends toward a projecting end thereof. Suppose here that, after the mirror 61 and the elastic member 51 are accommodated in the accommodating portion 841, the mirror 61 and the elastic member 51 are moved in such a direction as to cause a removal out of the accommodating portion 841. In this case, since the elastic member 51, including the return portions 54, is made of a metal or a resin which is harder than the flywheel 80, a portion of a surface of the flywheel 80 which defines a portion of the accommodating portion 841 is pressed by each return portion 54 and is depressed inward. In other words, in this case, the return portion 54 receives, from the inwardly depressed portion of the surface of the flywheel 80 which defines a portion of the accommodating portion 841, such a force as to press the return portion 54 back into the accommodating portion 841. This contributes to preventing the mirror 61 and the elastic member 51 from being removed out of the accommodating portion 841 or from being displaced. In the present preferred embodiment, the number of return portions 54 of the elastic member 51 is two. Note, however, that the number of return portions 54 is not limited to two.

The fixing portion 55 is arranged to support the mirror 61 in the direction in which the mirror 61 and the elastic member 51 are inserted into the accommodating portion 841. Specifically, the fixing portion 55 is arranged to be in contact with an upper end portion of the mirror 61. The mirror 61 is held between a bottom portion of the accommodating portion 841 and the fixing portion 55. This contributes to preventing the mirror 61 and the elastic member 51 from being removed out of the accommodating portion 841 or from being displaced after the mirror 61 and the elastic member 51 are accommodated in the accommodating portion 841.

In the present preferred embodiment, the elastic member is accommodated in the accommodating portion 841 with the elastic member 51 being arranged on a rear surface (i.e., the lower surface 612 of the mirror 61) side of the mirror 61. Note, however, that the elastic member 51 may alternatively be accommodated in the accommodating portion 841 with the elastic member 51 being arranged on a front surface (i.e., the upper surface 611 of the mirror 61) side of the mirror 61. That is, it is sufficient if the elastic member 51 is arranged to support at least a portion of one of a front surface and a rear surface of the mirror 61, while another one of the front surface and the rear surface of the mirror 61 is directly supported by at least a portion of a surface of the flywheel 80 which defines a portion of the accommodating portion 841, after the mirror 61 and the elastic member 51 are accommodated in the accommodating portion 841. In either case, the mirror 61 is securely fixed in the accommodating portion 841 by being supported by the elastic member 51 and the surface of the flywheel 80 which defines a portion of the accommodating portion 841 even when the size of the accommodating portion 841 or the contact surface has a low degree of precision. In addition, in this situation, at least a portion of the surface of the flywheel 80 which defines a portion of the accommodating portion 841 is arranged to be in direct contact with the mirror 61. Then, the flywheel 80 is pressed by the mirror 61 where the at least a portion of the surface of the flywheel 80 which defines a portion of the accommodating portion 841 is in direct contact with the mirror 61.

Next, one of the elastic members 5 which is arranged to hold the lens 63, which is one of the optical components 90, will now be described below. The one of the elastic members 5 which is arranged to hold the lens 63 will be hereinafter referred to as the “elastic member 52”. In the following description, differences from the elastic member 51, which is arranged to hold the mirror 61, will be mainly described, while features equivalent to those of the elastic member 51 will not be described to avoid redundancy.

Referring to FIGS. 4 and 6, a cut portion 803 is defined in a radially outer portion of a portion of the outer cylindrical portion 83 above the through hole 800 at one circumferential position. At least a portion of each of an outer circumferential surface and an upper surface of the cut portion 803 is arranged to be in communication with an outside of the flywheel 80. In addition, the accommodating portion 842, which is a space in the shape of a plate, is defined by the cut portion 803, the through hole 800, and an outer recessed portion 804, which is recessed downward from a surface of the outer cylindrical portion 83 which faces a lower end of the through hole 800. In FIG. 6, the accommodating portion 842 is represented by a chain double-dashed line. The accommodating portion 842 is arranged to be larger than the lens 63.

Similarly to the above-described elastic member 51, which is attached to the mirror 61, the elastic member 52 includes a plate-shaped main body 50, spring portions 53, return portions 54, and a fixing portion 55. At least a portion of the elastic member 52 is attached to the peripheral portion of the lens 63 through, for example, adhesion, soldering, welding, screwing, or engagement before the lens 63 is inserted and fixed in the flywheel 80. This contributes to securely fixing the elastic member 52 and the lens 63 to each other, and to preventing a displacement of the lens 63 with respect to the elastic member 52. In addition, fixing the elastic member 52 to the peripheral portion of the lens 63 contributes to preventing the light path of the reflected light 62, which is obtained by the mirror 61 reflecting the incoming light 60 and which passes through the lens 63, from being blocked.

The lens 63 and the elastic member 52 are inserted into the accommodating portion 842 with the elastic member 52 being fixed to the peripheral portion of the lens 63. At this time, the lens 63 and the elastic member 52 are inserted into the accommodating portion 842 in such a manner that the lens 63 will face radially outward. Each spring portion 53 of the elastic member 52 is arranged to be capable of expanding and contracting in a direction perpendicular to a direction (i.e., a direction in which the lens 63 and the elastic member 52 are inserted into the accommodating portion 842, that is, the direction indicated by the straight-line arrow in FIG. 7) in which the lens 63 extends. That is, the spring portion 53 is arranged to be capable of expanding and contracting in a thickness direction of the plate-shaped lens 63. This allows the lens 63 and the elastic member 52 to be easily inserted into the accommodating portion 842 even when the thickness of the plate-shaped accommodating portion 842, or a contact surface between a surface of the flywheel 80 which defines a portion of the accommodating portion 842 and the lens 63 or the elastic member 52, has a low degree of precision. Further, provision of the return portions 54 and the fixing portion 55 contributes to securely fixing the lens 63 and the elastic member 52 in the accommodating portion 842 after the lens 63 and the elastic member are accommodated in the accommodating portion 842. This contributes to preventing a displacement of the lens 63.

### 2. Example Modifications

While preferred embodiments of the present invention have been described above, it is to be understood that the present invention is not limited to the above-described preferred embodiments.

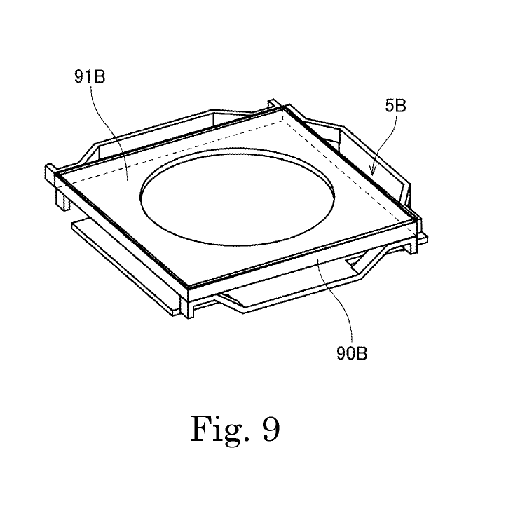

FIG. 9 is a perspective view of an optical component 90B and an elastic member 5B according to a modification of the first preferred embodiment. In the modification illustrated in FIG. 9, a resin protective member 91B is fixed to the optical component 90B such that a surface of the optical component 90B which is not opposed to the elastic member 5B is covered with the resin protective member 91B. When and after the optical component 90B and the elastic member 5B are inserted into an accommodating portion of a flywheel, at least a portion of a surface of the flywheel which defines a portion of the accommodating portion is arranged opposite to the optical component 90B with the resin protective member 91B intervening therebetween. This prevents a direct contact between the optical component 90B and the at least a portion of the surface of the flywheel which defines a portion of the accommodating portion, and thus contributes to preventing the optical component 90B from being damaged when and after the optical component 90B is inserted into the accommodating portion.

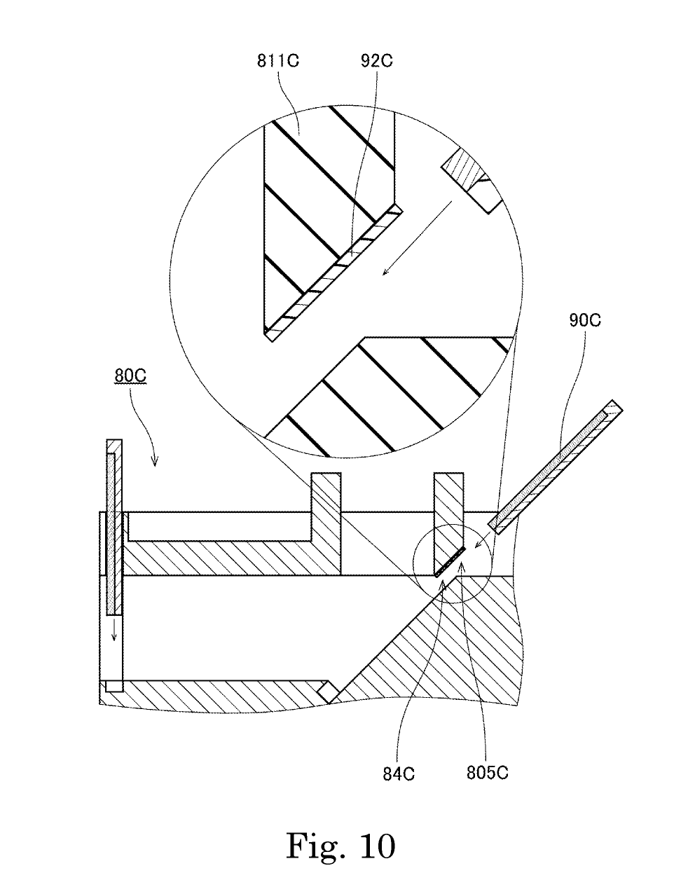

FIG. 10 is a partial vertical sectional view of a flywheel 80C according to another modification of the first preferred embodiment. The flywheel 80C further includes an opening protective member 92C fixed to at least a portion of an upper vertical cylindrical portion 811C of the flywheel 80C. The opening protective member 92C is fixed to a portion of the upper vertical cylindrical portion 811C, the portion abutting on an opening 805C of an accommodating portion 84C, the opening 805C being connected to a space exterior to the accommodating portion 84C. Then, at least a portion of the portion of the upper vertical cylindrical portion 811C which abuts on the opening 805C is opposed to an optical component 90C with the opening protective member 92C intervening therebetween when the optical component 90C is inserted into the accommodating portion 84C. This contributes to preventing the optical component 90C from being damaged when the optical component 90C is inserted into the accommodating portion 84C.

In the above-described preferred embodiment, each elastic member includes the plate-shaped main body, the spring portions, the return portions, and the fixing portion. Note, however, that it is sufficient if an elastic member according to a preferred embodiment of the present invention includes at least one or more of a plate-shaped main body, a spring portion, a return portion, and a fixing portion.

Also note that the detailed shape of any member may be different from the shape thereof as illustrated in the accompanying drawings of the present application. Also note that features of the above-described preferred embodiments and the modifications thereof may be combined appropriately as long as no conflict arises.

Preferred embodiments of the present invention are applicable to, for example, rotary drive apparatuses.

Features of the above-described preferred embodiments and the modifications thereof may be combined appropriately as long as no conflict arises.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A rotary drive apparatus arranged to rotate a flywheel arranged to support an optical component arranged to reflect incoming light coming from a light source or allow the incoming light to pass therethrough, the rotary drive apparatus comprising:
a motor including a rotating portion;
the flywheel, the flywheel being supported by the motor and arranged to rotate about a central axis extending in a vertical direction; and
an elastic member; wherein
the flywheel includes an accommodating portion in which the optical component is arranged; and
in the accommodating portion, at least a portion of the optical component is arranged opposite to at least a portion of the flywheel with the elastic member intervening therebetween.

2. The rotary drive apparatus according to claim 1, wherein the optical component is one of a mirror arranged to reflect the incoming light and a lens arranged to allow reflected light obtained by reflection of the incoming light by the mirror to pass therethrough.

3. The rotary drive apparatus according to claim 2, wherein
the optical component is the mirror; and
the elastic member is attached to a peripheral portion of a reflecting surface of the mirror.

4. The rotary drive apparatus according to claim 2, wherein
the optical component is the lens; and
the elastic member is attached to a peripheral portion of the lens.

5. The rotary drive apparatus according to claim 1, wherein the elastic member is defined by a single monolithic member.

6. The rotary drive apparatus according to claim 1, wherein
the optical component is arranged to extend in a shape of a plate; and
the elastic member includes a spring portion arranged to be capable of expanding and contracting in a direction perpendicular to a direction in which the optical component extends.

7. The rotary drive apparatus according to claim 6, wherein the elastic member is arranged to support at least a portion of one of a front surface and a rear surface of the optical component; and
the flywheel includes a surface defining a portion of the accommodating portion, and another one of the front surface and the rear surface of the optical component is supported by at least a portion of the surface of the flywheel.

8. The rotary drive apparatus according to claim 1, wherein the optical component is arranged to extend in a shape of a plate; and
the elastic member includes a return portion arranged to project from at least a portion of the elastic member in a direction away from the optical component with respect to a direction perpendicular to a direction in which the optical component extends, the return portion being angled in a direction opposite to a direction in which the optical component is inserted into the accommodating portion as the return portion extends toward a projecting end thereof.

9. The rotary drive apparatus according to claim 1, wherein the elastic member includes a fixing portion arranged to support the optical component in a direction in which the optical component is inserted into the accommodating portion.

10. The rotary drive apparatus according to claim 1, wherein the flywheel includes a surface defining a portion of the accommodating portion, and at least a portion of the surface of the flywheel is arranged to be in direct contact with the optical component.

11. The rotary drive apparatus according to claim 10, wherein the flywheel is pressed by the optical component where the at least a portion of the surface of the flywheel is in direct contact with the optical component.

12. The rotary drive apparatus according to claim 1, further comprising a resin protective member fixed to the optical component, wherein the flywheel includes a surface defining a portion of the accommodating portion, and at least a portion of the surface is arranged opposite to the optical component with the resin protective member intervening therebetween.

13. The rotary drive apparatus according to claim 1, wherein
the optical component is a mirror arranged to reflect the incoming light; and
at least a portion of the elastic member is attached to a peripheral portion of the mirror through adhesion, soldering, welding, screwing, or engagement.

14. The rotary drive apparatus according to claim 1, wherein
the optical component is a lens arranged to allow reflected light obtained by reflection of the incoming light to pass therethrough; and
at least a portion of the elastic member is attached to a peripheral portion of the lens through adhesion, soldering, welding, screwing, or engagement.

15. The rotary drive apparatus according to claim 1, wherein the accommodating portion is arranged to be larger than the optical component.

16. The rotary drive apparatus according to claim 8, wherein the flywheel includes a surface defining a portion of the accommodating portion, and a portion of the surface is pressed by the return portion and is depressed inward.

17. The rotary drive apparatus according to claim 1, wherein the elastic member is made of a metal.

18. The rotary drive apparatus according to claim 1, wherein the elastic member is made of a resin harder than the flywheel.

19. The rotary drive apparatus according to claim 1, further comprising an opening protective member fixed to at least a portion of a portion of the flywheel, the portion of the flywheel abutting on an opening of the accommodating portion, the opening being connected to a space exterior to the accommodating portion, wherein the at least a portion of the portion of the flywheel abutting on the opening is arranged opposite to the optical component with the opening protective member intervening therebetween.
